(19) United States
(12) Patent Application Publication
(10) Pub. No.: US 2020/0032644 A1
(43) Pub. Date: Jan. 30, 2020

(54) TEMPERATURE-CORRECTED DISTRIBUTED FIBER-OPTIC SENSING

(71) Applicant: Halliburton Energy Services, Inc., Houston, TX (US)

(72) Inventors: Hua Xia, Huffman, TX (US); Kristoffer Thomas Walker, Kingwood, TX (US); David Andrew Barfoot, Houston, TX (US); Yinghui Lu, Saratoga, CA (US)

(21) Appl. No.: 16/337,855

(22) PCT Filed: Nov. 17, 2016
(86) PCT No.: PCT/US2016/062544

§ 371 Date: Mar. 28, 2019

(51) Int. Cl. E21B 47/12; G01D 5/353; E21B 47/04

(52) U.S. Cl. CPC E21B 47/123; G02B 6/4415; E21B 47/04; G01D 5/35358

(57) ABSTRACT

In distributed fiber-optic sensing within a borehole, the accuracy of correlating signal channels with depth along the borehole can be improved by taking the thermo-optic effect on the group velocity of light into account. In an example application, this allows, in turn, to more accurately localize acoustic sources via distributed acoustic sensing. Additional embodiments are disclosed.

### BACKGROUND

Fiber-optic cables can be used in boreholes as linear, distributed sensors for measuring various physical properties or conditions as a function of depth along the borehole. To interrogate the sensor, light (e.g., emitted by a laser in the infrared regime) is sent downhole through the fiber, and backscattered light is measured as a response signal at the surface. Light scattered at deeper locations within the borehole will occur at later times within the response signal, due to the longer distance travelled. To process the response signal, the signal is often subdivided into segments of fixed duration (e.g., ten nanoseconds), called “signal channels” (or simply “channels”), which are correlated to different respective fiber sections and, thus, different depths within the borehole. A channel may include as few as a single data sample, or multiple data samples (if the sampling rate exceeds the desired spatial resolution of the measurements.)

The properties of various types of backscattered light may be affected by, and thus carry information about, different physical properties. For example, in Raman-backscattering-based distributed sensing techniques, the intensity ratio of the Stokes and anti-Stokes sidebands in the backscattered light depends on the temperature at the scattering location. Thus, the response signal, measured as a function of time (or channel number), can be processed to determine the temperature as a function of depth within the borehole. As another example, in coherent-Rayleigh-backscattering-based techniques, the fiber acts as a distributed interferometer for light pulses, resulting in intensity variations in the response signal. Changes between successive pulses in the intensity of backscattered light from the same section of fiber indicate changes in the optical path length of that fiber section, which may result, e.g., from changes in temperature or strain. Strain on the fiber may be caused, in turn, by acoustic waves, as may result, e.g., from leaks in or near the borehole. Accordingly, fiber-optic sensing facilitates distributed acoustic sensing for the detection and localization of leaks or other acoustic sources. Conventional methods of correlating the time, or channel, within the response signal with the depth along the borehole are, however, somewhat inaccurate, often resulting in uncertainties of several meters in the determined location of the acoustic sources.

### BRIEF DESCRIPTION OF THE DRAWINGS

FIG. 1 is a diagram of an example fiber sensing system with a fiber cable lowered into the borehole in a wireline operation, in accordance with various embodiments.

FIG. 2 is a diagram of an example fiber sensing system with a fiber cable permanently deployed in a borehole annulus, in accordance with various embodiments.

FIG. 3 is a graph of the phase velocity and group velocity of light in silica as a function wavelength, in accordance with various embodiments.

FIG. 4 is a graph of the relative change in the group velocity of light in silica at a center wavelength of about 1.55 μm as a function of temperature, in accordance with various embodiments.

FIG. 5 is a graph of the channel size corresponding to 10 ns channels of a 1.55 μm light pulse signal as a function of temperature, in accordance with various embodiments.

FIGS. 6A-B is a table of example values of various quantities as a function of depth within a borehole, illustrating channel uncertainty due to the thermo-optic effect, and compensation for this effect, in accordance with various embodiments.

FIG. 7 is a flow chart of a method for distributed fiber-optic sensing that involves taking the thermo-optic effect into account when correlating signal channels with depth within the borehole, in accordance with various embodiments.

FIG. 8 is a block diagram of a computational facility for processing fiber-optic signals, in accordance with various embodiments.

### DETAILED DESCRIPTION

Described herein are systems and methods for distributed fiber-optic sensing within a borehole that take the thermo-optic effect, i.e., the temperature-dependence of the group velocity of light, into account when correlating the time, or channel, within the response signal with a depth along the borehole. In various embodiments, the temperature along the borehole is determined, e.g., by measurement via distributed temperature sensing or wireline logging using a point sensor, or by inference from the known temperature distribution in a nearby borehole. Based on the temperature, in conjunction with knowledge of the thermal dependence of the group velocity within the fiber material and at the wavelength of interest, the dependence of the group velocity on the depth within the borehole is computed. The depth-dependent group velocity is then used to compute the spatial channel size for each channel (that is, the length of the optical-fiber section from which backscattered light within the channel originates) and/or the position along the fiber that corresponds to the channel (which equals the cumulative channel sizes up to that position). Further, the position along the fiber is correlated to depth along the borehole. The “depth” along the borehole, as used herein, denotes a position along a longitudinal axis of the borehole, measured downhole from the wellhead, regardless of the orientation of the borehole. In many instances, the borehole will go vertically into the ground, such that the depth along the borehole corresponds to geological depth. However, the borehole may also include oblique or horizontal sections, in which case the “depth” as used herein refers to the distance from the wellhead measured along the borehole axis, which may be potentially curved.

Temperature-corrected fiber-optic sensing in accordance herewith may be applied in various distributed sensing techniques. In some embodiments, it is used in distributed acoustic sensing (DAS) to locate leak-induced acoustic signals more accurately than conventional methods allow. In some embodiments, it is used in distributed temperature sensing (DTS) to obtain the temperature along the borehole at higher accuracy than the temperature estimate that goes into the correction for the thermo-optic effect.

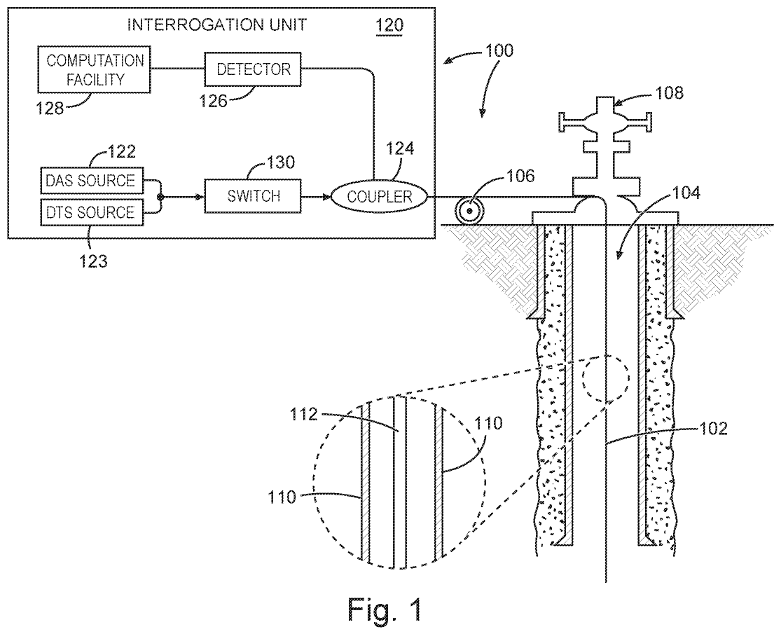

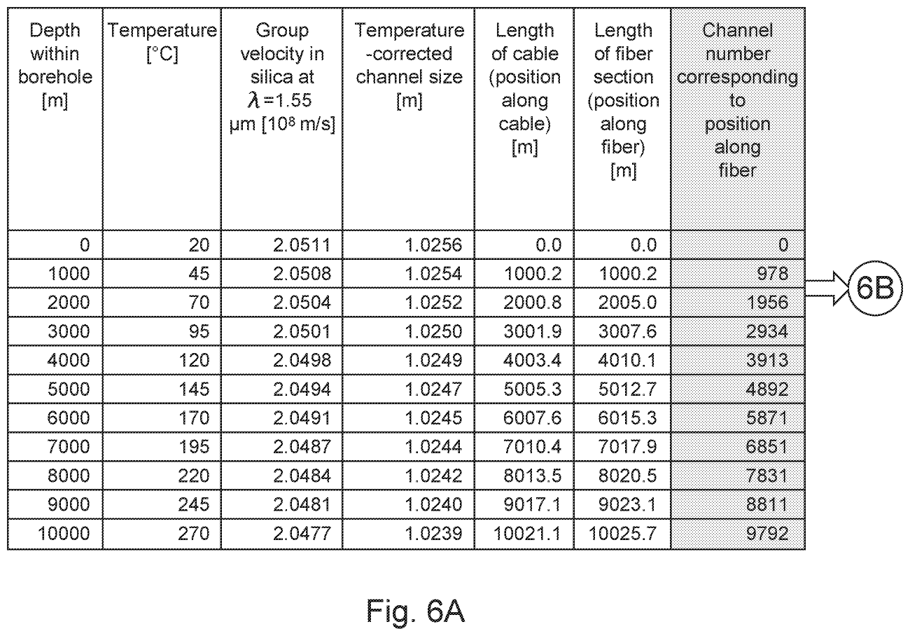

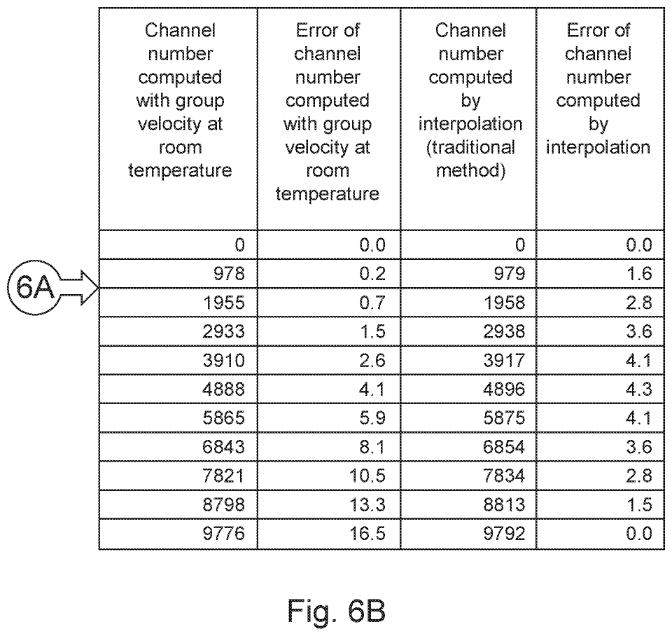

FIG. 1 is a diagram of an example fiber sensing system 100 with a fiber cable 102 lowered into the borehole 104 in a wireline operation, in accordance with various embodiments. As shown, the fiber cable 102 is wound around the spool 106 of a winch located above surface. As the spool 106 rotates, the length of wound-out fiber cable 102 is tracked, allowing points along the fiber cable 102 to be correlated to depth within the borehole 104. While, to first order approximation, the length of the wound-out portion of the fiber cable 102 (measured from the bottom of the wellhead 108) equals the depth within the borehole, a more accurate correlation can be made by accounting for two factors that generally cause the length of the cable to increase relative to its original length when wound up: thermal expansion due to the higher temperatures at increasing depths within the borehole 104, and cable stretching under the force of its own weight. Numerical values for the thermal expansion of a cable are provided in the table shown in FIG. 6. The increase in cable length ΔL due to gravitational-stress expansion can be computed from the original length L, the cross-sectional area A, the mass per unit length μ=m/L (where m is the total mass), and the elastic (Young's) modulus E of the cable as follows:

$$Δ L = {\int }_{0}^{L} \frac{μ gz}{AE} dz = \frac{mgL}{2 AE}$$

As shown in the blow-up detail drawing in FIG. 1, the fiber cable 102 may include a tubular metal (e.g., steel) sheathing 110 enclosing one or more glass fibers; the ends of the glass fiber(s) 112 are fixedly attached to the ends of the sheathing. Since the thermal expansion of metal significantly exceeds that of glass, the glass fiber would likely break due to the greater expansion of the sheathing if the two were originally of equal length. To avoid such breaking, some extra length of fiber (e.g., 10 m, 25 m, or 50 m) is usually loaded into the metal sheathing 110. For example, a nominally 10,000-meter-long cable 102 may be loaded with a nominally 10,025-meter-long glass fiber 112, with the extra twenty-five meters of fiber 112 being distributed more or less evenly over the length of the cable 102 in the form of undulations or curling. When the full length of this cable 102 has been unwound as the cable 102 is lowered into the borehole 104, the sheathing 110 may have extend to about 10,021 meters and the fiber to about 10,026 meters, for example.

The fiber sensing system 100 further includes an interrogation unit 120 located above surface. This unit 120 includes one or more light sources 122, 123 to generate the light to be sent through the one or more fibers 110, an optical coupler 124 to couple the light from the source(s) 122, 123 into the fiber(s) 110 and couple out the backscattered light, and a data acquisition system including a detector device 126 to measure the response signal(s) and a computational facility 128 to process the measured response signal(s). The light source(s) 122, 123 and detector device 126, as well as the optical fiber(s) 112, may be adapted to the particular sensing technique employed. For DTS based on Raman backscattering, a broadband light source 122 operating, for instance, in the infrared regime (e.g., with a bandwidth of tens or hundreds of Gigahertz and a center wavelength around 1.5 micrometers) may be used; suitable sources include, for example, various laser diodes. The optical fiber 110 used in conjunction with such a broadband light source is usually a multi-mode fiber. To separate out the wavelength-shifted Stokes and anti-Stokes sidebands from light backscattered at the wavelength of the incoming light (that is, from Rayleigh-backscattered light), the detector device 126 may include suitable wavelength filters. Alternatively, DTS can be performed with time-domain inelastic optical phonon backscattering (also in the art referred to as Brillouin backscattering), wherein the peak of the Brillouin sideband is measured to determine mechanical strain on the fiber, which is, in turn, temperature-dependent. For DAS using coherent Rayleigh backscattering, a narrowband light source 123 (e.g., with a bandwidth of several kilohertz), such as, e.g., an Erbium-doped fiber laser, which operates in the telecom C-band (e.g., between about 1530 and 1565 nm), may be used, usually in conjunction with a single-mode fiber (although a multi-mode fiber 110 can also be used in some embodiments).

In the fiber-sensing system 100, multiple light sources 122, 123 may be employed in order to enable different sensing techniques, for instance, as shown, both DAS and DTS. In this case, an optical switch 130 between the sources 122, 123 and the optical coupler 124 may enable selecting which of the light sources 122, 123 is used at any given time. Alternatively, the two light sources 122, 123 may be used simultaneously. This may be beneficial, for instance, during borehole operations such as fracking, where the temperature in the borehole 104 can change over short periods of time, rendering a real-time temperature determination desirable to correct DAS measurements in accordance herewith. The two sources 122, 123 may couple light into two separate respective optical fibers 110, which may be included in a single fiber cable or belong to two separate cables. Alternatively, the light from both sources 122, 123 may be coupled into the same optical fiber 110. In this case, unless an optical switch 130 is used to temporally separate the signals, the light sources 122, 123 are configured to operate at two different wavelengths.

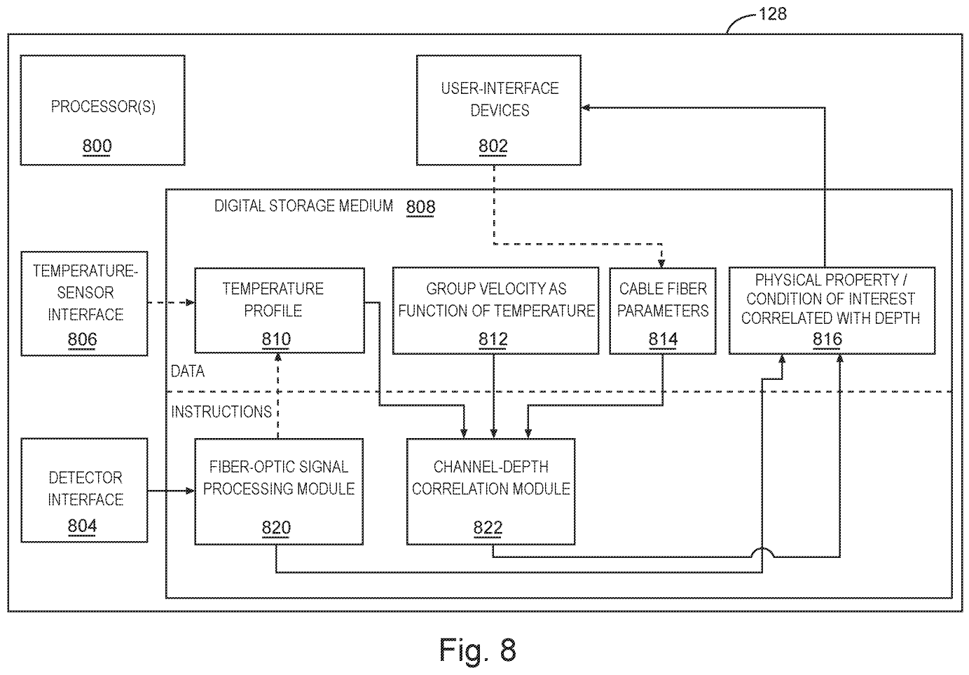

The computational facility 128 may be or include one or more special-purpose processing devices (such as, e.g., a digital signal processor or field-programmable gate-array) or a suitably programmed general-purpose processor. For example, in some embodiments, the computational facility 128 is implemented with a general-purpose computer (including, e.g., one or more central-processing units and associated system memory, an interface for connection to the detector device 126, typically one or more permanent data storage devices and user input/output devices, and a bus interconnecting the various components) in conjunction with software for analysis of the response signal(s). The software may be written in any of a number of programming languages, including, e.g., C, C++, Object C, Basic, Fortran, Pascal, or a language used in conjunction with other software, such as the commercially available tools MATLAB® (by MathWorks, Inc., Natick, Mass.) or LabVIEW® (by National Instruments Corporation, Austin, Tex.). An example computational facility is described in more detail below with reference to FIG. 8.

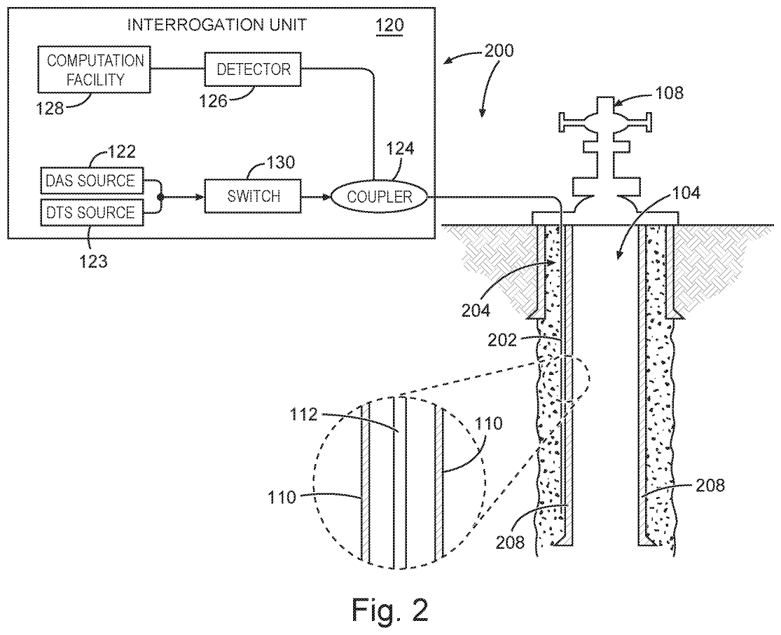

FIG. 2 is a diagram of an example fiber sensing system 200 with a fiber cable 202 permanently deployed in a borehole annulus 204 of a cased borehole 104, in accordance with various embodiments. The cable 202 may be clamped or otherwise affixed to the exterior of the borehole casing 208 and cemented in place along with the casing 208. In this case, the length of the cable 202 is set by the length of the casing string between the highest and lowest affixation points. To avoid a mismatch between the thermal expansion coefficients for the cable sheathing and the casing 208, the same material (e.g., steel) may be used for both. Further, the weight of the cable 202 is supported at distributed affixation points along the casing 208, preventing cable stretching due to the weight. The permanently installed fiber cable 202 may be interrogated with the same kind of interrogation unit 120 as is used with a fiber cable deployed wireline-style. In some embodiments, both a permanently installed fiber cable 202 and wireline cable 102 are used in a borehole 104, e.g., in conjunction with an interrogation unit 120 including two light sources 122, 123.

The optical fiber 112 functions as a waveguide that enables light-pulse propagation without significant loss across thousands of kilometers. The phase velocity Vₚₕ of light propagation, which is the ratio of the angular frequency ω and the wavenumber k=2π/λ, depends on the phase refractive index n of the fiber material:

$${v}_{p h} = \frac{c}{n} ,$$

where c is the speed of light in vacuum. The phase refractive index, in turn, is a function of the wavelength λ. At room temperature, the phase refractive index of pure silica—the main material of the optical fiber 110—is given by the Sellmeier equation:

$${n}^{2} = 1 + \frac{0.6961663 {λ}^{2}}{{λ}^{2} - {( 0.0684043 )}^{2}} + \frac{0.4079426 {λ}^{2}}{{λ}^{2} - {( 0.1162414 )}^{2}} + \frac{0.8974794 {λ}^{2}}{{λ}^{2} - {( 9.896161 )}^{2}} .$$

Due to dispersion in the fiber (i.e., different phase velocities for light of different wavelengths), a pulse of light (which includes a range of wavelengths) travels with a different velocity, called the group velocity V_{gr}. The group velocity depends on the phase velocity Vₚₕ, wavenumber k (or wavelength λ), and phase refractive index n as follows:

$${v}_{g r} = {v}_{p h} ( 1 - \frac{k}{n} \cdot \frac{dn}{dk} ) .$$

The group velocity gives rise to the definition of a group refractive index as:

$${n}_{g r} ≡ \frac{c}{{v}_{g r}} .$$

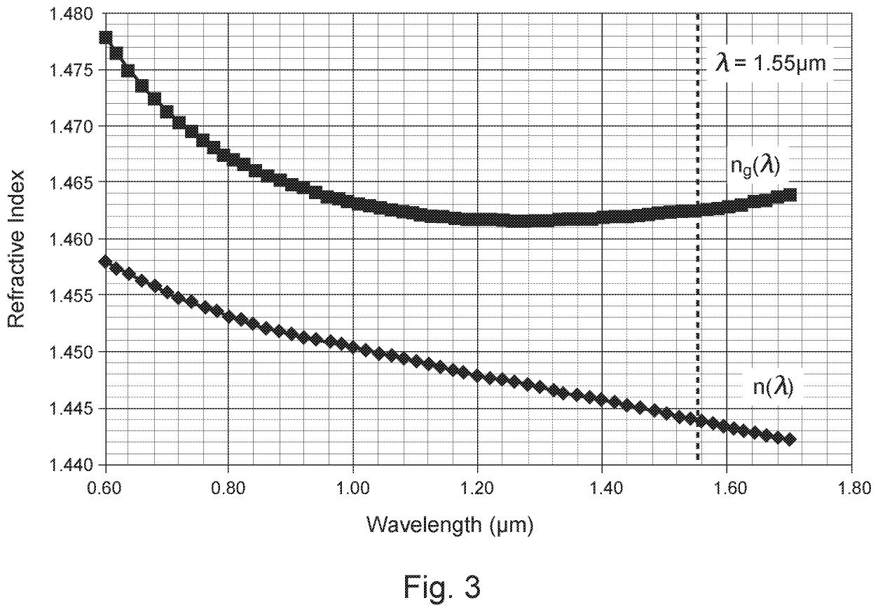

FIG. 3 is a graph of the phase velocity and group velocity of light in a pure silica fiber as a function wavelength. At 1.55 μm, the phase refractive index is about 1.4440 and the group refractive index is about 1.4626.

The group refractive index is thermally dependent, and can be written as:

$${n}_{g r} ( T ) = {n}_{g r} ( {T}_{0} ) \cdot [ 1 + β ( T - {T}_{0} ) ] ,$$

where the thermo-optic coefficient β is about 9.6-10⁻⁶/K, T₀ is a reference temperature (e.g., room temperature), and n_{gr} (T₀) is the group refractive index at the reference temperature. From this relation and the above expression for the group velocity follows the temperature dependence of the group velocity:

$$\begin{matrix}{v}_{g r} ( T ) = \frac{c}{{n}_{g r} ( {T}_{0} ) \cdot [ 1 + β ( T - {T}_{0} ) ]} \\ \approx \frac{c}{{n}_{g r} ( {T}_{0} )} [ 1 - β ( T - {T}_{0} ) ]\end{matrix}$$

$$\begin{matrix}{v}_{g r} ( T ) \approx {v}_{g r} ( {T}_{0} ) [ 1 - β ( T - {T}_{0} ) ] \\ = \frac{c}{n ( {T}_{0} )} {( 1 - \frac{k}{n} \cdot \frac{dn}{dk} )}_{T = {T}_{0}} [ 1 - β ( T - {T}_{0} ) ]\end{matrix}$$

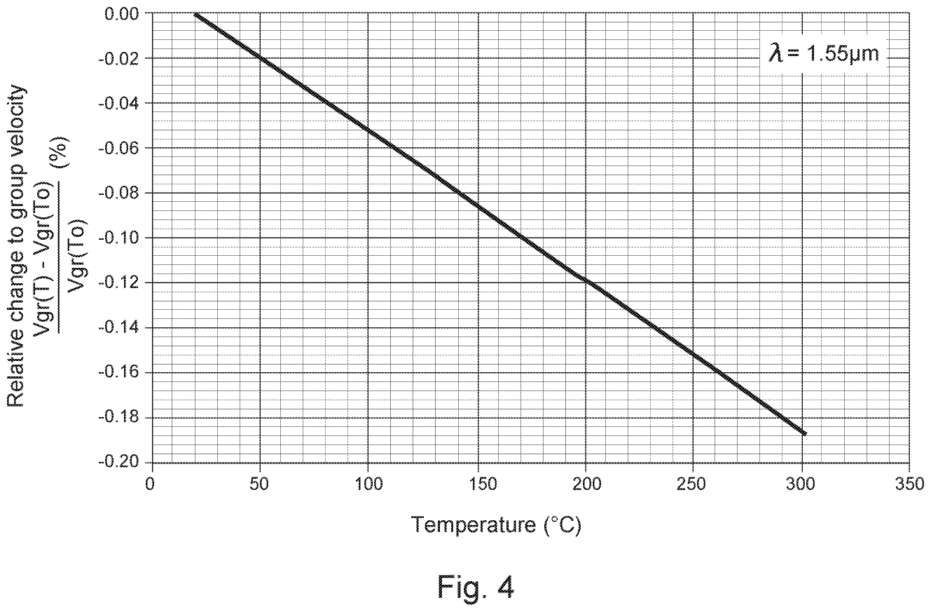

FIG. 4 is a graph of the relative change in the group velocity of light at a center wavelength of about 1.55 μm as a function of temperature. As can be seen, light-pulse propagation slows down at elevated temperatures due to the thermo-optic effect. At 200° C., as are often reached in downhole environments, the relative slow-down is about 0.12%.

In accordance with various embodiments, the optical response signals are acquired and/or processed in segments of fixed duration, e.g., each being 10 ns long. For instance, the response signal may be sampled at 100 kHz, resulting in one data sample per channel. Alternatively, the signal may be sampled at a higher (e.g., three times the) rate, and multiple (e.g., three) successive data samples together may be processed as one channel. Of course, channel durations shorter or longer than 10 ns may be used, depending on the feasibility of sampling rates and the desired resolution of the measurements in the borehole. For a given channel duration r, the additional length ξ of optical fiber per channel that the light traverses (in both directions), herein referred to as “channel size,” is given by

$$ξ ( T ) = \frac{τ}{2} \cdot {v}_{g r} ( T ) .$$

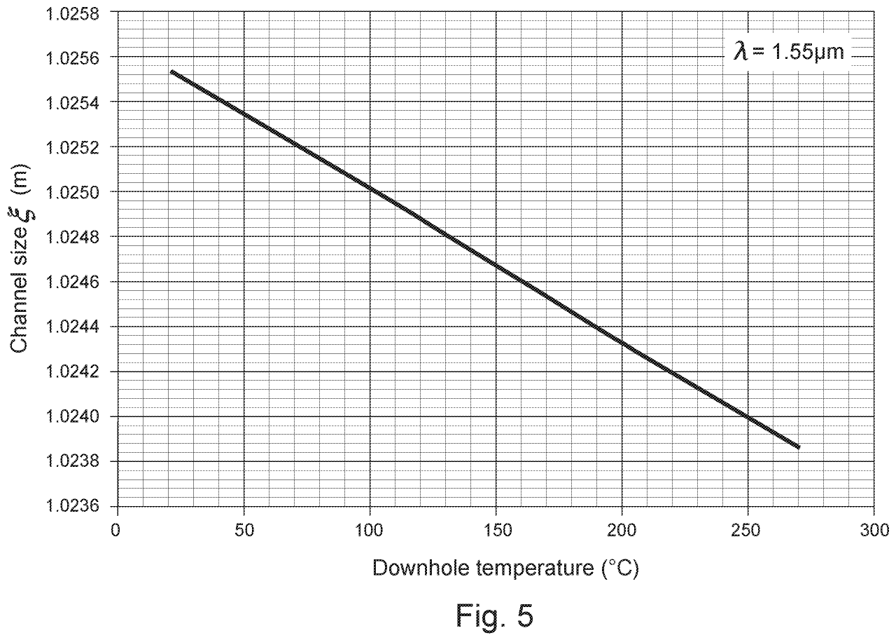

When the group velocity at which light travels through the optical fiber slows down due to the thermo-optic effect, the channel size decreases. This is illustrated in FIG. 5, which shows a graph of the channel size corresponding to 10 ns channels of a 1.55 μm light pulse signal as a function of temperature. As can be seen, the channel size reduces from about 1.0256 m at 20° C. (room temperature) to about 1.024 m at 250° C. If this change in channel size is not accounted for in the computation of the total length travelled along the optical fiber corresponding to N channels, the accumulated downhole depth error is:

$$Δ L = {\sum }_{i = 1}^{N} \frac{τ}{2} \cdot [ {v}_{g r} ( {T}_{i} ) - {v}_{g r} ( {T}_{0} ) ] .$$

FIG. 6 is a table of example values of various quantities as a function of depth within a borehole, illustrating channel uncertainty due to the thermo-optic effect, and compensation for this effect in accordance with various embodiments. In this example, the borehole is assumed to go vertically into the ground, such that the depth within the borehole corresponds to geological depth. The first column indicates the depth within the borehole, shown in 1000-m increments from 0 (surface) to a depth of 10,000 m. The second through fourth columns show the temperature (in accordance with an example depth-dependence), temperature-dependent group velocity of light in silica fiber at 1.55 μm, and temperature-corrected channel size as a function of the depth.

Assume that, for example, a nominally 10,000-m-long stainless-steel-sheathed fiber cable with a nominally 10,025-m-long silica fiber is disposed in the borehole. The fifth and six columns show the length, measured from the surface, of sections of the cable and fiber ending at various depths in the borehole (or, in other words, the position along the cable or fiber as measured from the surface), taking thermal expansion into account. As indicated, the cable expands to 10,021.1 m, and the fiber to 10,025.7 m. Of course, the thermal expansion shifts the end of the cable to a borehole depth of 10,021.1 m, where the temperature is generally slightly higher, and the group velocity and channel size thus slightly smaller, than at 10,000 m, and all other points along the cable are similarly down-shifted. As a person of ordinary skill in the art will readily appreciate, this second-order correction is, however, small compared with the correction to account for the thermo-optic effect in the first place, and can be neglected in correlating channel numbers to positions along the fiber for most practical purposes. (Note, however, that the expansion of the cable may be, and usually is, taken into account when correlating position along the fiber with depth along the borehole, as explained further below.)

The seventh column provides the channel number corresponding to the position along the optical fiber (measured from the surface) indicated in the sixth column. The channel number j corresponding to a given position x along the fiber is chosen such that the channel sizes add up to x:

x=Σᵢ₌₁^{j(x)}ξᵢ.

For comparison, the eight column shows the channel number calculated with the group velocity at room temperature, i.e., neglecting the thermo-optic effect. In this case, channel number is computed by dividing the position x along the fiber by the channel size at room temperature, 1.0256 m. As shown, this calculation results in channel number 9776 at the end of the fiber, compared with channel number 9792 for the thermally corrected calculation underlying column seven—a difference corresponding to about 16 m. The ninth column shows the error in the determined channel depth (measured in meters) at various positions along the fiber.

As another point of comparison, the tenth column shows the channel numbers obtained by determining the number of the last channel from a direct measurement (e.g., via optical time domain reflectometry) of the time it takes light to travel down to the deep end of the fiber and back up to the detector, and linear interpolation of the channel number between the two ends of the fiber. This method of correlating channel number to positions along the fiber results in the correct channel number of 9792 for the last channel, but still causes errors in channel number at the points of interpolation, as can be seen from the eleventh column, which provides the channel depth error resulting from the difference between the channel numbers between the tenth and seventh columns. As shown, the error in channel number is greatest for the channels at positions about the middle of the fiber, where it amounts to more than 4 m.

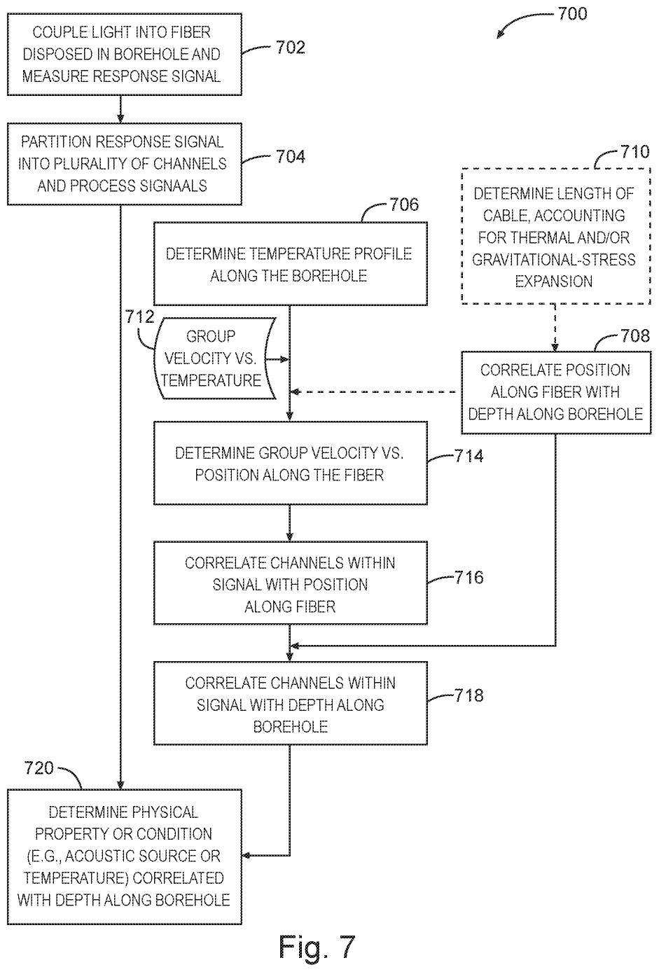

FIG. 7 is a flow chart of an example method 700 for distributed fiber-optic sensing that involves, in accordance with various embodiments, taking the thermo-optic effect into account when correlating signal channels with depth within the borehole. The method 700 involves, at operation 702, coupling light into an optical fiber disposed in a borehole (e.g., optical fiber 112 of a wireline cable 102 or a cable 202 attached to borehole casing) and measuring a response signal that includes light backscattered at locations throughout a length of the optical fiber. In doing so, a suitable light source and detector (e.g., including filters to extract certain wavelengths from the backscattered light) may be utilized to implement, e.g., distributed acoustic or thermal sensing techniques. The measured response signal is temporally partitioned into channels (e.g., each corresponding to 10 ns of signal, or some other fixed time interval) and processed to determine a value of a physical property (e.g., an acoustic property or temperature) for each channel (operation 704).

In order to account for the thermo-optic effect when computationally correlating the channels with the depth along the borehole, the method 700 further involves, at operation 706, determining the temperature profile along the borehole, e.g., as a function of depth. The temperature may, for example, be measured sequentially at various depths with a thermally-sensitive point sensor lowered into the borehole on a wireline (or in some other manner), or using conventional distributed temperature sensing (which is not corrected for the thermo-optic effect) to obtain an approximate temperature profile. Alternatively, the temperature profile along the borehole at issue may be inferred from measurements of the temperature in a nearby borehole, or determined based on other a-priori information, such as, for vertical boreholes, the known dependence of the temperature on geological depth. From the temperature as a function of depth along the borehole, the temperature as a function of the position along the fiber may be derived. Alternatively, in some embodiments, the temperature is measured directly as a function of position along the fiber, using distributed temperature sensing either in the same fiber as is used to obtain the response signal of interest (e.g., employing different wavelengths for the two signals) or in a separate fiber of equal length enclosed in the cable.

If the temperature profile is determined initially as a function of depth, computationally correlating depth along the borehole with the position along the fiber (operation 708) may be accomplished in several ways. In some embodiments, depth and position along the fiber are simply equated under the approximating assumption that the fiber extends straight down into the borehole without any curling. In other embodiments, a more accurate position along the fiber is calculated by multiplying the depth along the borehole with the ratio of the nominal fiber length to the nominal cable length to account for the extra length of fiber that is typically loaded into the cable, or by using that ratio with the further refinement of cable and/or fiber lengths determined, at operation 710, taking into account deviations from the nominal length(s), e.g., due to thermal or gravitational-stress expansion. Based on the temperature profile along the borehole in conjunction with the correlation between depth and position along the fiber and further with knowledge of the group-velocity of the light in the fiber and its dependence on the temperature (indicated at 712) (which can be determined experimentally and may be stored in memory, e.g., in the form of a look-up table or an analytic expression), the group velocity of the light can be determined as a function of position along the fiber (operation 714). The position along the fiber can be correlated with channels within the signal (operation 716) by multiplying the group velocity at a given position along the fiber with the channel duration to determine the respective channel size, and then adding the channel sizes up to the given position. Using the relationship between position along the fiber and depth along the borehole (determined at operation 708), the signal channels can be correlated with depth along the borehole (operation 718). This, in turn, allows correlating the physical property or condition obtained by processing the response signal (at operation 704) with depth along the borehole (operation 720). For example, leaks or other acoustic sources may be located in depth along the borehole.

FIG. 8 is a block diagram of a computational facility 128, in accordance with various embodiments, for processing fiber-optic signals to implement, for example, the computational operations of the method 700 of FIG. 7. As shown, the computational facility 128 may include one or more processors 800 (e.g., central processing units (CPUs)), user-interface devices 802 (e.g., keyboard and mouse and an LCD screen or other display device), a detector interface 804 to connect to the detector 126 that receives the response signal(s), optionally a temperature-sensor interface 806 for connecting to a separate temperature sensor, and one or more digital storage media 808 (which may include both volatile system memory and non-volatile storage devices such as a hard disk, CD-ROM, etc., and associated drives). The digital storage media 808 may store both data flowing into or resulting from the various computations, as well as instructions for carrying out the computations (in FIG. 8 separated from the data by a dashed line), which may be grouped into computational modules. The stored data may include a temperature profile 810 for a given borehole (e.g., as measured with a temperature sensor and read in via the temperature-sensor interface 806), the group velocity as a function of temperature 812 (which may come pre-loaded into a permanent storage device, as it depends only on the fiber material and wavelength, and is generally independent of the particular borehole environment in which the system is used), cable and/or fiber parameters 814 (which may, e.g., be entered via user-interface devices 802), and the output of the computations, that is, data 816 providing the physical property or condition of interest, correlated with depth along the borehole.

The computational modules may include a fiber-optic signal processing module 820 that receives the measured response signal(s) via the detector interface 804 and computes the property of interest for each channel, and a channel-depth correlation module 822 that computationally associates each channel with the depth within the borehole based on the temperature profile 810, group velocity as a function of temperature 812, and/or cable/fiber parameters 814. The combined output of these two modules 820, 822 yields the physical property or condition of interest correlated with depth (data 816), which may be communicated to a user via user-interface devices 802, or provided as input to other software or computational devices (e.g., a graphing program or device controller). In embodiments that employ distributed temperature sensing, the temperature profile 810 itself may result from processing of the input response signal (or one of multiple input response signals). Of course, the depicted grouping into modules 820, 822 represents only one example implementation among multiple possible ways of organizing the instructions for providing the functionality disclosed herein.

Beneficially, taking the temperature dependence of the group velocity into consideration when processing fiber-optic response signals in accordance with system and methods as described herein can increase the accuracy with which the measured physical properties or conditions are located in a borehole, as compared, for example, with traditional methods that simply interpolate between the end points of the fiber as illustrated in the last two columns of FIG. 6. Furthermore, in contrast to the traditional method, which no longer works if the fiber breaks (because, in this case, it is unknown which depth the lower end of the upper fiber section corresponds to), the presently disclosed approach would still function for the upper fiber section in a broken fiber.

The following numbered examples are illustrative embodiments:

1. A method comprising: coupling light into an optical fiber disposed in a borehole, and measuring a response signal comprising light backscattered at locations throughout a length of the optical fiber; determining a temperature profile along the borehole; based at least in part on the determined temperature profile and a wavelength of the light, determining a group velocity of the light as a function of at least one of the depth along the borehole or position along the optical fiber; and computationally correlating a plurality of channels within the measured response signal with respective depths along the borehole based at least in part on the determined group velocity.

2. The method of example 1, wherein computationally correlating the plurality of channels with respective depths along the borehole comprises: computationally correlating the plurality of channels with respective positions along the optical fiber based at least in part on the determined group velocity; and computationally correlating positions along the optical fiber with respective depths along the borehole.

3. The method of example 2, wherein computationally correlating the positions along the optical fiber with respective depths along the borehole is based on a length of a cable enclosing the optical fiber.

4. The method of example 3, wherein computationally correlating the positions along the optical fiber with respective depths along the borehole comprises determining the length of the cable based at least in part on at least one of a temperature of the cable and an elongation of the cable under its own weight.

5. The method of any of the preceding examples, wherein the measured response signal comprises a coherent Rayleigh backscattering signal.

6. The method of example 5, further comprising processing the response signal to determine an acoustic property along the borehole.

7. The method of example 6, further comprising detecting and localizing one or more leaks based on the acoustic property.

8. The method of any of examples 1-4, wherein the measured response signal comprises one of an inelastic optical phonon scattering signal or a Raman backscattering signal.

9. The method of example 8, further comprising processing the measured response signal to determine the temperature as a refined function of depth along the borehole.

10. The method of any of the preceding examples, wherein the temperature is determined as a function of position along the optical fiber by distributed temperature sensing.

11. The method of any of examples 1-9, wherein the temperature is determined as a function of depth along the borehole by measuring the temperature with a point sensor in a wireline logging operation.

12. A system comprising: at least one optical fiber to be disposed in a borehole; at least one light source to emit light to be coupled into the at least one optical fiber; a detector to measure at least one response signal comprising light backscattered at locations throughout a length of the optical fiber; and a computational facility to compute, based at least in part on a temperature determined as a function of at least one of a depth along the borehole or a position along the optical fiber and on a wavelength of the light, a group velocity of the light as a function of at least one of the depth along the borehole or the position along the optical fiber, and computationally correlate a plurality of channels within the at least one measured response signal with respective depths along the borehole based at least in part on the computed group velocity.

13. The system of example 12, wherein at least one of the at least one optical fiber is affixed to an exterior of a borehole casing.

14. The system of example 12, wherein at least one of the at least one optical fiber is suspended into the borehole from a winch.

15. The system of any of examples 12-14, wherein the computational facility is to further process the measured response signal to determine at least one of a physical property or a physical condition correlated with the depth along the borehole.

16. The system of example 15, wherein the physical property or the physical condition comprises at least one of a temperature or an acoustic source.

17. The system of any of examples 12-16, wherein the at least one light source comprises a narrow-linewidth laser, the detector being configured to measure a coherent Rayleigh backscattering response signal, and the computational facility to process the response signal to locate one or more acoustic sources along the borehole.

18. The system of any of examples 12-17, wherein the at least one light source comprises a broad-linewidth laser, the detector being configured to measure a Raman backscattering signal, and the computational facility to process the response signal to determine a temperature as a function of the depth along the borehole.

19. The system of any of examples 12-18, wherein the detector is to measure first and second response signals, and the computational facility is to compute the temperature as a function of position along the optical fiber based on the first response signal, and to computationally correlate a plurality of channels within the second response signal with respective depths along the borehole based at least in part on the group velocity computed based on the temperature.

20. The system of example 19, comprising first and second light sources to emit light into first and second respective optical fibers, the first response signal comprising light backscattered in the first optical fiber and the second response signal comprising light backscattered in the second optical fiber.

Many variations may be made in the system, devices, and techniques described and illustrated herein without departing from the scope of the inventive subject matter. Accordingly, the described embodiments are not intended to limit the scope of the inventive subject matter. Rather, the scope of the inventive subject matter is to be determined by the scope of the following claims and all additional claims supported by the present disclosure, and all equivalents of such claims.

What is claimed is:

1. A method comprising:
coupling light into an optical fiber disposed in a borehole, and measuring a response signal comprising light backscattered at locations throughout a length of the optical fiber;
determining a temperature profile along the borehole;
based at least in part on the determined temperature profile and a wavelength of the light, determining a group velocity of the light as a function of at least one of the depth along the borehole or position along the optical fiber; and
computationally correlating a plurality of channels within the measured response signal with respective depths along the borehole based at least in part on the determined group velocity.

2. The method of claim 1, wherein computationally correlating the plurality of channels with respective depths along the borehole comprises:
computationally correlating the plurality of channels with respective positions along the optical fiber based at least in part on the determined group velocity; and
computationally correlating positions along the optical fiber with respective depths along the borehole.

3. The method of claim 2, wherein computationally correlating the positions along the optical fiber with respective depths along the borehole is based on a length of a cable enclosing the optical fiber.

4. The method of claim 3, wherein computationally correlating the positions along the optical fiber with respective depths along the borehole comprises determining the length of the cable based at least in part on at least one of a temperature of the cable and an elongation of the cable under its own weight.

5. The method of claim 1, wherein the measured response signal comprises a coherent Rayleigh backscattering signal.

6. The method of claim 5, further comprising processing the response signal to determine an acoustic property along the borehole.

7. The method of claim 6, further comprising detecting and localizing one or more leaks based on the acoustic property.

8. The method of claim 1, wherein the measured response signal comprises one of an inelastic optical phonon scattering signal or a Raman backscattering signal.

9. The method of claim 8, further comprising processing the measured response signal to determine the temperature as a refined function of depth along the borehole.

10. The method of claim 1, wherein the temperature is determined as a function of position along the optical fiber by distributed temperature sensing.

11. The method of claim 1, wherein the temperature is determined as a function of depth along the borehole by measuring the temperature with a point sensor in a wireline logging operation.

12. A system comprising:
at least one optical fiber to be disposed in a borehole;
at least one light source to emit light to be coupled into the at least one optical fiber;
a detector to measure at least one response signal comprising light backscattered at locations throughout a length of the optical fiber; and
a computational facility to
compute, based at least in part on a temperature determined as a function of at least one of a depth along the borehole or a position along the optical fiber and on a wavelength of the light, a group velocity of the light as a function of at least one of the depth along the borehole or the position along the optical fiber; and
computationally correlate a plurality of channels within the at least one measured response signal with respective depths along the borehole based at least in part on the computed group velocity.

13. The system of claim 12, wherein at least one of the at least one optical fiber is affixed to an exterior of a borehole casing.

14. The system of claim 12, wherein at least one of the at least one optical fiber is suspended into the borehole from a winch.

15. The system of claim 12, wherein the computational facility is to further process the measured response signal to determine at least one of a physical property or a physical condition correlated with the depth along the borehole.

16. The system of claim 15, wherein the physical property or the physical condition comprises at least one of a temperature or an acoustic source.

17. The system of claim 12, wherein the at least one light source comprises a narrow-linewidth laser, the detector being configured to measure a coherent Rayleigh backscattering response signal, and the computational facility to process the response signal to locate one or more acoustic sources along the borehole.

18. The system of claim 12, wherein the at least one light source comprises a broad-linewidth laser, the detector being configured to measure a Raman backscattering signal, and the computational facility to process the response signal to determine a temperature as a function of the depth along the borehole.

19. The system of claim 12, wherein the detector is to measure first and second response signals, and the computational facility is to compute the temperature as a function of position along the optical fiber based on the first response signal, and to computationally correlate a plurality of channels within the second response signal with respective depths along the borehole based at least in part on the group velocity computed based on the temperature.

20. The system of claim 19, comprising first and second light sources to emit light into first and second respective optical fibers, the first response signal comprising light backscattered in the first optical fiber and the second response signal comprising light backscattered in the second optical fiber.
